(19) United States
(12) Patent Application Publication
(10) Pub. No.: US 2023/0306200 A1
(43) Pub. Date: Sep. 28, 2023

(54) SYSTEM AND METHOD FOR GEOGRAPHICAL DISTANCE-BASED DEEP REPRESENTATION AND LEARNING THEREOF FOR USER LOCATION PREDICTION

(71) Applicant: YAHOO ASSETS LLC, Dulles, VA (US)

(72) Inventors: Liuqing Li, Santa Clara, CA (US); Rao Shen, Sunnyvale, CA (US); Yu Wang, Sunnyvale, CA (US); Yufeng Ma, Santa Clara, CA (US); Kostas Tsioutsiouliklis, Saratoga, CA (US); Donghyun Kim, San Francisco, CA (US)

(21) Appl. No.: 17/702,506

(22) Filed: Mar. 23, 2022

(51) Int. Cl. G06F 40/284; G06N 3/04; G06F 40/242

(52) U.S. Cl. CPC G06F 40/284; G06N 3/04; G06F 40/242

(57) ABSTRACT

The present teaching relates to method, system, medium, and implementations for characterizing data. A location feature is first received. A distance-aware embedding for the received location feature is obtained, where the distance-aware embedding for the location feature is learned based on distances between different pairs of locations. A representation of the location feature is then generated based on the embedding for location related predictions.

### BACKGROUND

### 1. Technical Field

The present teaching generally relates to data processing. More specifically, the present teaching relates to data representation and derivation thereof.

### 2. Technical Background

With the development of the Internet and the ubiquitous network connections, more and more commercial and social activities are conducted online. Online content is served or recommended to millions at different locations. Advertising is more and more shifted to online and ads are displayed to users while content is delivered to the users. To make online content serving or recommendation to be provided in a more targeted manner, much effort has been exercised in the industry to optimize the content selection process to maximize the return. Different factors have been considered during targeting, including some categorical features of context associated with each opportunity. Examples of such categorical features are shown in FIG. 1A, which may include features that characterizing connection type, locations of users, . . . , and IP domains. Knowing a user's location information enables content platforms to provide better personalized experiences, such as showing geographically relevant content and ads. As such, accurate estimation of a user location is an important task in online services across various fields, such as recommendation systems, event detection, and disaster management.

Some location related features may have a fixed vocabulary, such as zip codes, and some may have an open vocabulary, such as IP addresses. Conventional methods to predicting a user's location are shown in FIG. 1B (PRIOR ART). These traditional approaches include cache-based or rule-based models to produce an integrated score for each location and select a location with the highest score as the best prediction. Such heuristic methods have moderate performance that can be further improved. Deep learning models have recently demonstrated reasonable performance in terms of user location prediction by considering various types of raw user information. Such information includes metadata features (e.g., user description, profile location, time zone), text features (e.g., locations in posts or comments), network features (e.g., IP address, hostname), external features (e.g., prediction from other sources), etc.

A deep learning model for predicting a location takes, e.g., the above features as input, and automatically learns meaningful information from those features to infer a user's location. Most of these prior art methods focus on improving the prediction accuracy via optimizing deep learning models. However, such approaches do not concern about how to represent the features (feature representation learning) to make the learning more effective. It is widely recognized that the quality of feature representation in training samples has a significant impact on the performance of a model learned via deep learning. Inappropriate representation of features may indeed lead to limited model performance, while carefully and accurately derived representations of features usually improve the performance of a model in downstream prediction tasks.

FIG. 1C (PRIOR ART) illustrates a commonly known as one hot vector 110 used for representing the zip code feature. With this representation, the one hot vector has multiple attributes, ZC1, ZC2, . . . , ZCn, each of which corresponds to one dimension. As a zip code feature has a fixed vocabulary, the dimension of the one hot vector 110 for zip code equals to the total number of zip codes in the U.S. For example, if there is a total of 41,000 zip codes in the United States (i.e., n=41,000), the one hot vector 110 has a dimension of 41,000, i.e., having 41,000 attributes, each of which corresponds to one of the zip codes in the vocabulary. For example, the first attribute corresponds to zip code 1 ZC1, the second attribute corresponds to zip code 2 ZC2, the third attribute corresponds to zip code 3 ZC3, . . . , and the nth attribute corresponds to zip code n ZCn.

Using a one hot vector to represent a specific zip code, each attribute may have a value of 1 or 0, with 1 indicating that the feature corresponds to a zip code indicated by the attribute and 0 indicating that the feature is a zip code that does not correspond to the attribute. This is illustrated in FIG. 1D, where each of the zip codes ZC1, ZC2, ZC3, . . . , ZCn is represented by a one hot vector with appropriate attribute values. For instance, for zip code 1 ZC1, its one hot vector representation is 110-1, having 1 for the first attribute related to zip code 1 ZC1 and 0 for all other attributes related to other zip codes; for zip code 2 ZC2, its one hot vector representation is 110-2, having 1 for the second attribute related to zip code 2 ZC2 and 0 for all other attributes; for zip code 3 ZC3, its one hot vector representation is 110-3, having 1 for the third attribute related to zip code 3 ZC3 and 0 for all other attributes; . . . , for zip code n ZCn, its one hot vector representation is 110-n, having 1 for the nth attribute related to zip code n ZCn and 0 for all other attributes. FIG. 1E illustrates an example with specific zip codes. Assume that ZC1 is the zip code for New York City, ZC2 is the zip code of San Francisco, and ZC3 for San Jose. Given that, the one hot vector representations of these three zip codes, are shown in FIG. 7E.

The one hot vector representation has several drawbacks. One is the problem associated with high dimensionality. As mentioned, in US alone, there are 41,000 zip codes, leading to a 41K dimensional vector for representing zip codes, which significantly enlarges the size of downstream location prediction model and further increases the cost of model training and inference. Another problem associated with using one hot vector representation for location is that is cannot be used directly to represent a location feature that has an open vocabulary. Yet another issue associated with one hot vector representation is that because each attribute is perpendicular to all other attributes, without considering any geographical information of locations and, hence, cannot and does not encode relative distances of different locations. For instance, in the example illustrated in FIG. 1E, the orthogonal representations for New York City, San Francisco, and San Jose, when projected in the high dimensional space, each takes a point along one dimension so that the three cities have the same distance in the vector space. This is shown in FIG. 1F, without any implication or representation the geographical relationship among different zip code regions. This not only increases the difficulties of model learning but also poses a negative impact on performance of a model learned based on such one hot vector representations of zip codes.

Thus, there is a need for a better representation for local features that can capture useful information that, once represented and learned, can enhance the performance of the traditional approaches.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for characterizing data. A location feature is first received. A distance-aware embedding for the received location feature is obtained, where the distance-aware embedding for the location feature is learned based on distances between different pairs of locations. A representation of the location feature is then generated based on the embedding for location related predictions.

In a different example, a system is disclosed for characterizing data. The system includes a location feature determiner configured for receiving a location feature and a location representation generator. The location representation generator is configured for obtaining an embedding related to the location feature with distance-awareness, wherein the embedding for the location feature is learned based on distances between different pairs of locations and generating a representation of the location feature based on the embedding, wherein the representation of the location feature using the embedding is to be used for location related predictions.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for characterizing data. The information, when read by the machine, causes the machine to perform various steps. A location feature is first received. A distance-aware embedding for the received location feature is obtained, where the distance-aware embedding for the location feature is learned based on distances between different pairs of locations. A representation of the location feature is then generated based on the embedding for location related predictions.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A-1F (PRIOR ART) describe problems to be addressed and prior art solutions;

FIG. 2A shows an exemplary characteristic to be captured by a representation for a location feature, in accordance with an embodiment of the present teaching;

FIG. 2B shows exemplary learned embeddings for different zip codes with a much smaller dimension, in accordance with an embodiment of the present teaching;

FIG. 3A depicts an exemplary high level system diagram of a zip code embedding learning mechanism for learning embeddings for a location feature with a fixed vocabulary, in accordance with an embodiment of the present teaching;

FIG. 3B is a flowchart of an exemplary process of a zip code embedding learning mechanism for learning embeddings for a location feature with a fixed vocabulary, in accordance with an embodiment of the present teaching;

FIG. 4A depicts an exemplary representation of a location feature that has an open vocabulary, in accordance with an exemplary embodiment of the present teaching;

FIG. 4B depicts a multilayer neural network for deriving an embedding for a location feature that has an open vocabulary, in accordance with an embodiment of the present teaching;

FIG. 5A depicts an exemplary high level system diagram of an IP address embedding learning mechanism for a local feature with an open vocabulary, in accordance with an exemplary embodiment of the present teaching;

FIG. 5B is a flowchart of an exemplary process of an IP address embedding learning mechanism for a local feature with an open vocabulary, in accordance with an exemplary embodiment of the present teaching;

FIG. 6A depicts an exemplary high level system diagram for obtaining an embedding of a location feature, in accordance with an embodiment of the present teaching;

FIG. 6B is a flowchart of an exemplary process for obtaining an embedding of a location feature, in accordance with an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses solutions of representing a category feature via embeddings and learning mechanisms thereof. The representation scheme for category features as disclosed herein may be used for both category features that have a fixed vocabulary and category features that have an open vocabulary. For a category feature that has a fixed vocabulary, such as zip codes, embeddings are obtained via machine learning by leveraging the geographical distances among different zip code as ground truth during learning so that the learned embeddings retain the semantic relative distances among different zip codes. For a category feature that has an open vocabulary, such as IP addresses, the present teaching as disclosed herein facilitates learning of embeddings of different IP addresses based on ground truth obtained via the coordinates of the IP addresses so that the semantic relative distances among different IP addresses are retained. The scheme for learning embeddings for IP addresses having an open vocabulary is not limited to presently known IP addresses but also for future IP addresses.

The category feature representation using embeddings as disclosed herein overcomes the shortcomings of prior art solutions. It has a significantly lower dimensionality than that of the prior art. For example, if one hot vector representation is used for, e.g., zip codes, the required dimension is 41,000 even just for zip codes in the USA. As will be seen below, the dimension of the embedding representation is much lower, e.g., 16 as opposed to 41,000 of the prior art. In addition, the embedding representations as disclosed herein are geographical distance aware because the embeddings are learned based on meaningful geographical distances corresponding to the location features. As discussed in the background, the prior art solutions are completely blind as it comes to geographical semantics. Furthermore, the embedding representation for location features with an open vocabulary, according to the present teaching, is capable of also being used for new features that have not existed previously.

The present teaching is presented first with respect to embedding representation and learning thereof for location features with a fixed vocabulary and then second with respect to embedding representation and learning thereof for local features having an open vocabulary such IP addresses. Although embeddings are used for both types of location features, due to the difference in their nature of a fixed or an open vocabulary, specifics in deriving the embeddings vary. For example, a zip code is a location feature with a fixed vocabulary. An IP address is an example of a location feature that has an open vocabulary. For instance, an IP address may have 12 or 16 or even more digits organized in a well formulated manner. Although having a known number of digits, existing IP addresses may not exhaust all possible combinations. That is, some of the IP addresses are known and can be used in learning to derive their embeddings and some may not yet be known (open vocabulary) and may emerge later as new and unknown feature values. The embedding scheme and learning process thereof according to the present teaching is capable of deriving embeddings for unknown vocabularies.

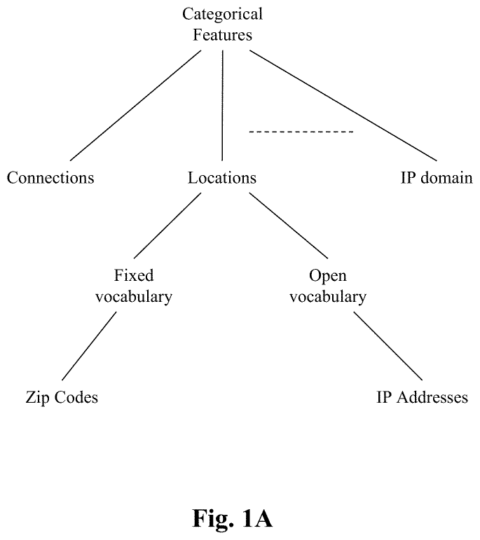

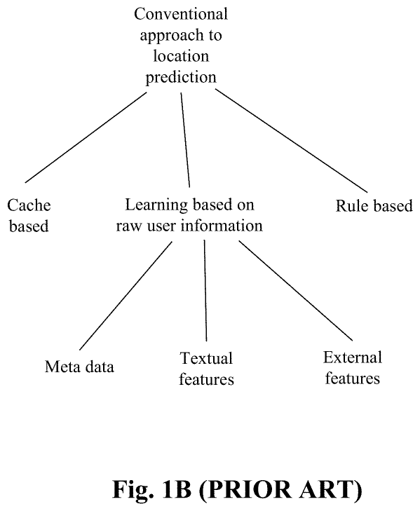

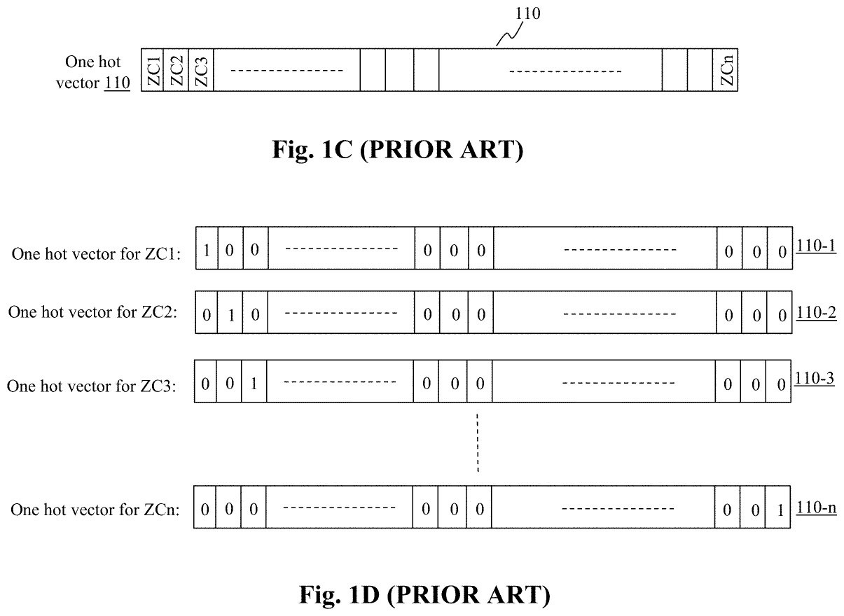

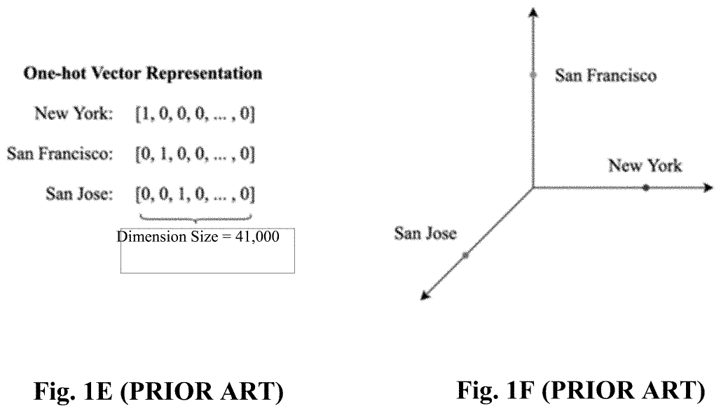

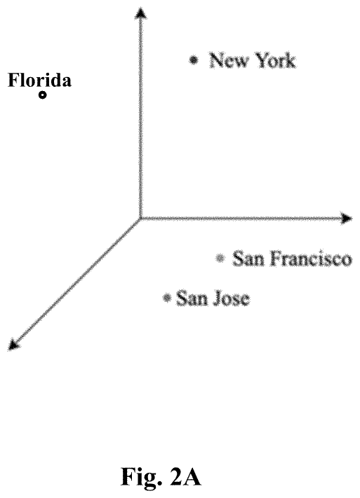

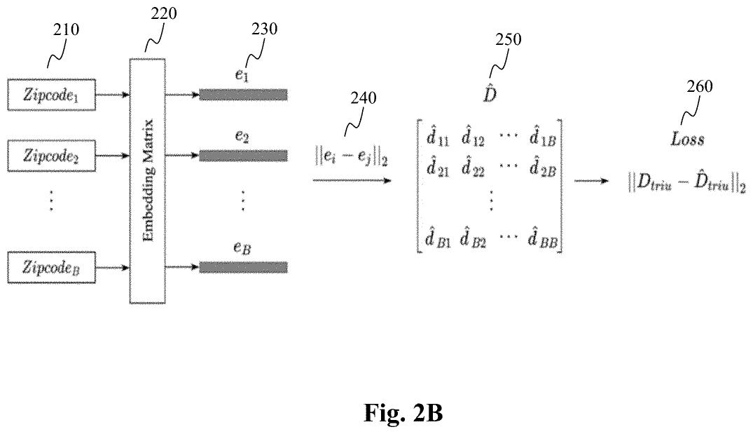

The discussion focuses first on embedding representation and learning thereof for local features that have a fixed vocabulary. Zip codes may be used to illustrate the concepts, not as a limitation. As shown in FIG. 1F, the one hot vector representation for zip codes is geographical distance blind. For example, when zip codes are represented using one hot vector, as the one hot vector representation for each zip code is perpendicular to all other vectors representing other zip codes, the distance between any two one hot vectors for any two zip codes is the same, as shown in FIG. 1F. To overcome this, a representation for a location feature is to be distance-aware so that representations of different location feature also capture the relative distances between different pairs of locations. This is shown in FIG. 2A, where embeddings derived via a learning process of the present teaching are distance-aware so that when the embeddings are projected in space, the relative distances reflect the geographical distances among the locations they represent, respectively. In this example, the embeddings for zip codes of San Francisco and San Jose have a smaller distance when compared with the distances between them and the embeddings representing the zip codes for New York and Florida. FIG. 2B shows exemplary learned embeddings for these different zip codes. As seen, each embedding is a vector of a certain dimension with a number of attributes therein with values. In this example, the dimension of the embeddings is 16, which is magnitude of smaller than the dimension of 41,000 required if one hot vector is used. The values of attributes in each embedding may corresponding to floating numbers whose values may be initialized, learned during a learning process, and ultimately converged when certain conditions are met.

The present teaching involves operations of three stages: 1) generate feature representation, 2) estimate pair-wise distances, and 3) optimize the feature representation via loss reduction. Generating feature representation focuses on providing a dimension reduced representation for zip codes. As discussed herein, embeddings of a certain dimension, e.g., 16, may be adopted and initialized with random numbers. Such embedding values may then be learned by minimizing a loss function to converge. For example, with respect to a fixed population of zip codes (e.g., 41K of U.S. zip codes), embeddings for such zip codes may first be initialized as a batch of [Zipcode₁, Zipcode₂, . . . , Zipcode_{b}], where b is the size of the population. This is shown in FIG. 2C, where 210 represents the zip code population and they are used to generate corresponding embeddings 230, including e₁, e₂, e₃, . . . , e_{b}. In some implementation, to derive the initial embeddings 230, a lookup table may be provided that stores an embedding matrix with a fixed dictionary and size. The output (embeddings for zip codes) may be represented as E_{b*|E|}=[e₁, e₂, e₃, . . . , e_{b}], where |E| is the size of each zip code embedding. As discussed herein, initially, each embedding may be a numeric vector with random values.

To train these embeddings against some optimization criteria, a loss function may be defined. In an exemplary embodiment, the loss function is defined so that the learned embeddings are distance-aware, i.e., the distances among different embeddings mimic the geographical distances among physical regions corresponding to the underlying zip codes. The initial embeddings derived using random numeric values may be used to compute pair wise distances 240 and such distances are used to construct an estimated distance matrix 250. The estimated pair-wise distances computed using the embeddings may be used as the basis for a loss function in order for adjusting the embedding values by minimizing the loss function. According to the present teaching, a loss function 260 is defined based on the difference between the distances estimated using embeddings and the distances among regions represented by the zip codes. As such, the loss function is made distance aware.

To learn the embeddings for zip codes, a batch of zip codes [Zipcode₁, Zipcode₂, . . . , Zipcode_{b}] are used to form into a simple lookup table that stores an embedding matrix with a fixed dictionary and size. The output includes the embeddings of the corresponding zip codes, represented as E_{Z}^{b×|e}^{_{Z}}^{|}=[e_{Z}¹, e_{Z}², . . . , e_{Z}^{b}] where b is the batch size and |e_{z}| is size of each zip code embedding. To train the embedding model, the similarity of each pair of embeddings may be computed based on, e.g., Euclidean Distance (ED). Given the embeddings E_{Z}^{b×|e}^{_{Z}}^{|} in a batch, the estimated distance matrix \hat{D}_{Z} is formulated as:

$${\hat{D}}_{Z} = E D ( {E}_{Z}^{b \times \vert {e}_{Z} \vert} , {E}_{Z}^{b \times \vert {e}_{Z} \vert} ) = [ \begin{matrix}{\hat{d}}_{Z}^{11} & {\hat{d}}_{Z}^{12} & … & {\hat{d}}_{Z}^{1 b} \\ {\hat{d}}_{Z}^{21} & {\hat{d}}_{Z}^{22} & … & {\hat{d}}_{Z}^{2 b} \\ ⋮ & ⋮ & ⋱ & ⋮ \\ {\hat{d}}_{Z}^{b 1} & {\hat{d}}_{Z}^{b 2} & … & {\hat{d}}_{Z}^{b b}\end{matrix} ]$$

where \hat{d}_{Z}^{ij} is the estimated Euclidean distance between two zip code embeddings e_{Z}ⁱ and e_{Z}^{j}, and the dimension of \hat{D}_{Z} is b×b. As discussed herein, the values in the embeddings are initialized with random numbers and they are adjusted during learning by minimize a loss function, which is defined based on discrepancy of the pair-wise distances estimated using the embeddings and that of the computed pair-wise distances of the zip codes determined based on the approach described below.

Each zip code has a region that it represents, and such a region has a center with a coordinate that can be obtained via publicly available information (e.g., from the world_knowledgeprd_database). The coordinates representing regions corresponding to different zip codes may be leveraged to compute the distance between any pair of zip codes. For example, given two zip codes Zipcodeᵢ and Zipcodeⱼ, the coordinates of centers of the regions they each correspond may be obtained, respectively. The coordinates may be represented by their respective longitude and latitude, i.e., (lonᵢ, latᵢ) (for Zipcodeᵢ) and (lonⱼ, latⱼ) (for Zipcodeⱼ), respectively. The physical distance distᵢⱼ between Zipcodeᵢ and Zipcodeⱼ may then be computed as follows:

$${dist}_{ij} = 2 r arcsin ( \sqrt{P + cos ( {lat}_{i} ) cos ( {lat}_{j} ) Q}$$

$$P = {sin}^{2} ( \frac{{lat}_{i} - {lat}_{j}}{2} ) , Q = {sin}^{2} ( \frac{{lon}_{i} - {lon}_{j}}{2} )$$

Here, r is the earth's radius (=6371). Based on such computed distance between a pair of zip codes, a normalized distance d_{Z}^{ij} for the pair can be determined as follows:

$${d}_{Z}^{ij} = 1 - \frac{log ( max ( dist ) + scale ) - log ( {dist}_{ij} + scale )}{log ( max ( dist ) + scale ) - log ( scale )}$$

$$scale = \frac{{K}^{2}}{max ( dist ) - 2 K}$$

where max(dist) is the maximum Haversine distance between all possible pairs of zip codes and K is a hyperparameter. In some embodiments, K=100 by default. The normalized real distance d_{Z}^{ij} is used as the ground truth between two zip codes. The normalized real distances are used as ground truth distances and they form a distance matrix Dz, where each element d_{Z}^{ij} in the matrix represents the normalized distance of a pair of zip codes.

Since both Dz and \hat{D}_{Z} are symmetric matrix, the upper triangular portion of each matrix is used to calculate the mean squared error (MSE) as the loss function defined below:

$$Loss = {\sum }_{i = 1}^{b} {\sum }_{j \geq i}^{b} {( {d}_{Z}^{ij} - {\hat{d}}_{Z}^{ij} )}^{2}$$

During the learning, embeddings for zip codes are learned by minimizing the Loss. In some embodiments, an Adam optimizer may be adopted with a set fixed learning rate while learning zip code embeddings.

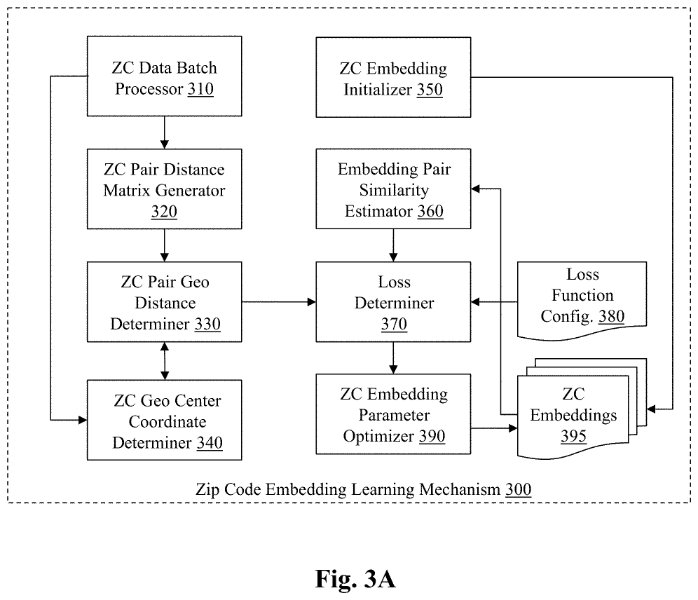

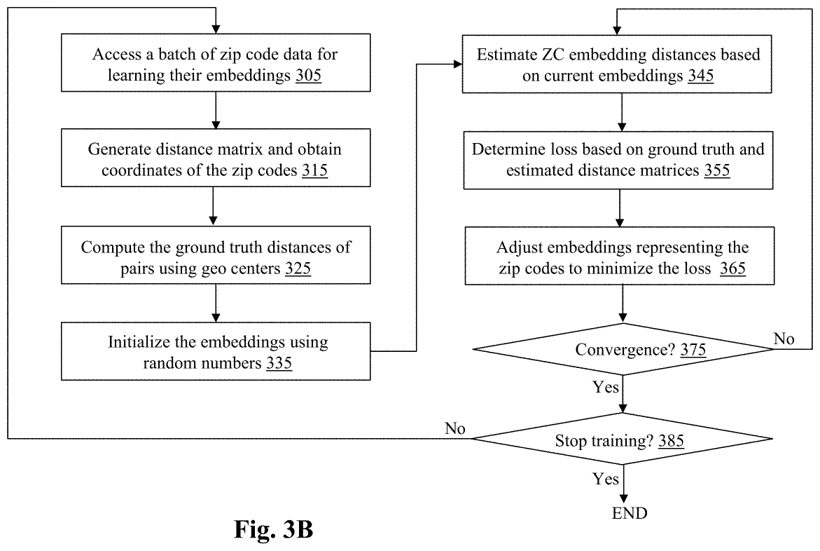

With the learning scheme as described above, the embeddings for zip codes can be derived in a manner so that they are distance aware. That is, the embeddings of two zip codes have a high similarity if both zip codes are geographically close to each other. FIG. 3A depicts an exemplary high level system diagram of a zip code embedding learning mechanism 300 for learning embeddings for a location feature with a fixed vocabulary, in accordance with an embodiment of the present teaching. In this exemplary embodiment, the location feature corresponds to zip codes and the learning of embeddings for zip codes utilizes the geographic centers of regions corresponding to the respective zip codes as ground truth. The zip code embedding learning mechanism 300 comprises a ZC data batching processor 310, a zip code (ZC) pair distance matrix generator 320, a ZC pair geo distance determiner 330, a ZC geo center coordinator determiner 340, a ZC embedding initializer 350, an embedding pair similarity estimator 360, a loss determiner 370, and a ZC embedding parameter optimizer 390.

FIG. 3B is a flowchart of an exemplary process of the zip code embedding learning mechanism 300 for learning embeddings for a location feature with a fixed vocabulary, in accordance with an embodiment of the present teaching. In operation, when the ZC data batch processor 310 received a batch of zip codes for training their embeddings, it activates the ZC pair distance matrix generator 320 and the ZC geo center coordinator determiner 340 to, at 315, generate a distance matrix and obtain coordinates of the centers of the zip codes in the batch. Based on the obtained coordinates for the centers of the zip codes, the ZC pair geo distance determiner 330 computes, at 325, the pair-wise distances, d_{Z}^{ij}, between different pairs of zip codes to generate the distance matrix Dz, which will be used to provide ground truth pair-wise distances to the loss determiner 370 to determine the loss. To estimate the pair-wise similarities (distances in Di), the ZC embedding initializer 350 first initializes, at 335, the embeddings for the zip codes in the batch with, e.g., random values. The initialized embeddings are then stored in as ZC embeddings in 395. Based on the embeddings stored in ZC embedding storage 395, the embedding pair similarity estimator 360 estimates, at 345, the similarities or distances, d_{Z}^{ij}, of different pairs of embeddings (representing corresponding zip codes) based on the values in current embeddings.

Based on the estimated embedding distances, d_{Z}^{ij}, and ground truth distances, d_{Z}^{ij}, the loss determiner 370 determines, at 355, the Loss as defined above. In some embodiments, the loss determiner 370 may compute the Loss based on a loss function specified in a loss function configuration 380. With respect to the computed Loss, the ZC embedding parameter optimizer 390 adjusts, at 365, the values in current embeddings to minimize the Loss. The adjusted embeddings may be stored in 395 as the current version of the learned embeddings. The learning process may be iterative, and the process may be controlled based on some pre-determined convergence condition or criteria. For instance, if the learning has not yet converged, determined at 375 based on the convergence condition, the learning may proceed to step 345 for the next iteration so that the current version of the embeddings may be used to compute embedding distances, \hat{d}_{Z}^{ij}, which may then be used to compute the Loss in the next iteration. The learning based on the current batch of zip codes will iterate until the embeddings for the zip codes in the bath converge. If there are more batches of zip codes, determined at 385, the embedding learning continues by returning to step 305, where another batch of zip codes is obtained and their embeddings are learned via the optimization scheme as disclosed herein.

As discussed herein, for a location feature with a fixed vocabulary, such as zip codes, the above-described learning scheme enables learning of distance-aware embeddings to represent zip codes. Such learned embeddings are used to represent zip codes in location prediction. The embeddings learned in this manner not only can represent zip codes in a more semantically meaningful way (distance-aware) but also have significantly lower dimension, making the downstream usage and application more efficient and accurate. As discussed herein, some location features do not have a fixed vocabulary. Instead, they have an open vocabulary, such as IP addresses. That is, even though an IP address may have a known number of digits, there are only a certain number of combinations in use. For example, there are IPV4 and IPV6 addresses, and they are designed with certain meaning. For instance, each raw IPV6 IP address has 32 hexadecimal digits, where the first 12 digits are for site prefix, the next 4 digits are for subnet ID, and the rest digits are for interface ID. As the interface ID in general has little impact on user location prediction, the first half (i.e., site prefix and subnet ID) may be considered for representation learning.

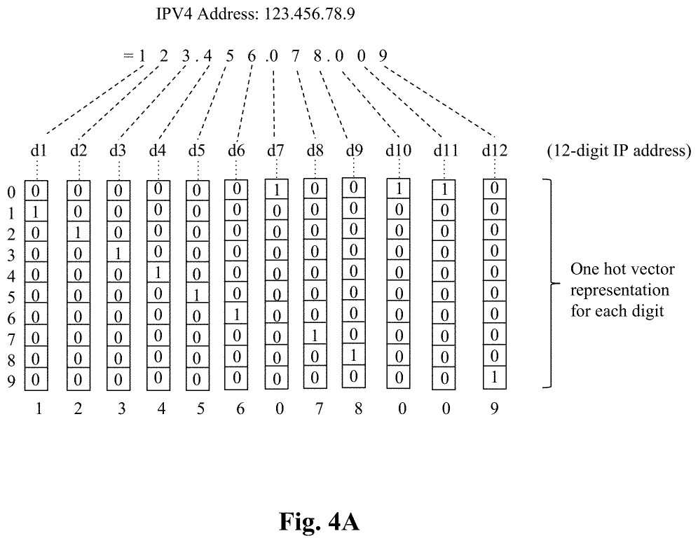

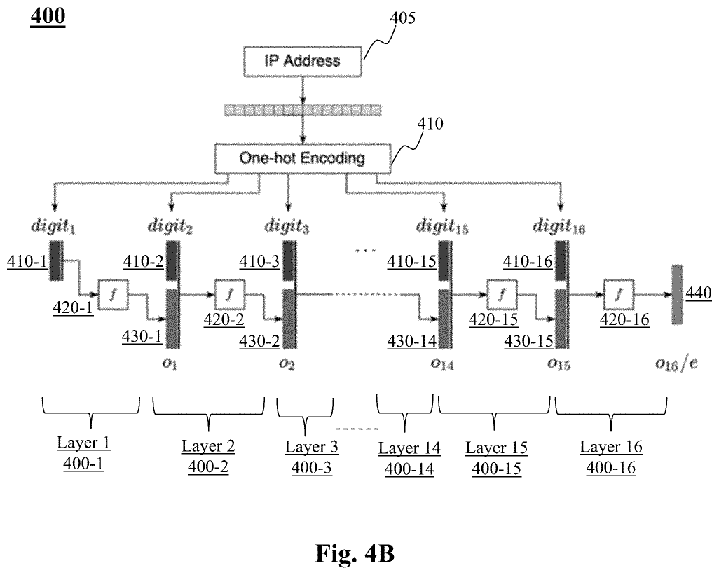

Given an IP address, it can be decompressed to ensure that each IPV4 IP address has 12 digits and each IPV6 IP address has 16 digits. For example, an IPV4 IP address 123.456.78.9 may be converted into [1, 2, 3, 4, 5, 6, 0, 7, 8, 0, 0, 9], while an IPV4 IP address 2001:19f0:200:4000:0:0:0:109 may be converted into [2, 0, 0, 1, 1, 9, f, 0, 0, 2, 0, 0, 4, 0, 0, 0]. FIG. 4A depicts an exemplary representation of a 12-digit IP address feature that has an open vocabulary, in accordance with an exemplary embodiment of the present teaching. As shown, the IP address 123.456.78.9 if first padded to 123.456.078.009 so that there are 12 digits, d1, d2, d3, . . . , d11, d12. Each of the digits can be represented by a one hot vector (dimension 10) with each attribute designated to one number between 0 and 9. For example, as d1=1, the one hot vector for d1 has 1 as the value for attribute for number 1 and 0 everywhere else; d2=2, the one hot vector for d2 has 1 as the value for attribute for number 2 and 0 everywhere else; d3=3, the one hot vector for d3 has 1 as the value for attribute for number 3 and 0 everywhere else; . . . , d10=0, the one hot vector for d10 has 1 as the value for attribute for number 0 and 0 everywhere else; d11=0, the one hot vector for d11 has 1 as the value for attribute for number 0 and 0 everywhere else; d12=9, the one hot vector for d12 has 1 as the value for attribute for number 9 and 0 everywhere else. In this example, the 12-digit IP address 123.456.78.9 is represented by 12 one hot vectors.

The similar mechanism may also be applied to, e.g., 16-digit IPV6 IP addresses. To develop a common framework for both types of IP addresses, four (4) zeros may be padded to the left of IPV4 digits to make it 16-digit as well so that there is a consistency in terms of digit length that can accommodate both IPV4 and IPV6 IP addresses. To generate an embedding for an EP address based on the multiple one hot vectors, the present teaching employs a multilayer neural network that takes one hot vectors for an IP address as input and outputs an embedding for the IP address by combine the one hot vectors. FIG. 4B depicts a multilayer neural network 400 for deriving an embedding for an IP address with an open vocabulary, in accordance with an embodiment of the present teaching. In this illustrated framework, the IP address has 16 digits. It is understood that this is merely for illustration and not as limitation. The framework as presented in FIG. 4B may be applied to an IP address with any number of digits.

The multilayer neural network framework 400 comprises different layers, e.g., 16 layers 400-1, 400-2, 400-3, . . . , 400-15, and 400-16 in this example. An IP address 400 may first be encoded (410) by using a one-hot vector for each digit to generate, e.g., 16 one hot vectors labeled as 410-1, 410-2, 410-3, . . . , 410-15, and 410-16, as shown in FIG. 4B. The dimension of each one hot vector for a digit is the number of all possible values of each digit, i.e., 0, 1, . . . , F. In operation, the one hot vector for digit, is fed to layer ith of the network, respectively. That is, the input xᵢ of the ith layer is the concatenation of digitᵢ with oᵢ₋₁, which is the output of the previous layer (except for the first layer). Specifically,

$${x}_{i} = \{ \begin{matrix}{digit}_{i}^{n \times 1} & i = 1 \\ concat ( {digit}_{i}^{n \times 1} , {o}_{i - 1}^{m \times 1} ) & i ∈ \{ 2 , 3 , ... , 12 \}\end{matrix}$$

where n is the dimension of the one-hot vector of each digit while m is the dimension of the IP representation. At each layer, the output oᵢ is a linear combination of the input xᵢ along with an activation function ƒ. That is,

$${o}_{i} = \{ \begin{matrix}f ( {w}_{i}^{m \times n} \cdot {x}_{i} + {b}_{i}^{m \times 1} ) i = 1 \\ f ( {w}_{i}^{m \times ( n + m )} \cdot {x}_{i} + {b}_{i}^{m \times 1} ) i ∈ \{ 2 , 3 , ... , 12 \}\end{matrix}$$

where wᵢ* and bᵢ* represent weights and biases, respectively. In some embodiments, random values are used to initialize all weights and biases.

In some embodiments, softsign may be used as the activation function ƒ, as it is more robust to saturation, resulting in more effective learning. The siftsign activation function may be expressed as:

$$f ( x ) = softsign ( x ) = \frac{x}{\vert x \vert + 1}$$

As a result, the multi-layer serial neural network 400 takes an IP address as input and produces, at the last layer, a corresponding embedding (016 or e in FIG. 4B). Because each IP address can be formatted as 16 digits, the multilayer neural network 400 is capable of encoding previously unseen IP addresses, and thereby is adaptive to all IP addresses. That is, the framework according to the present teaching can be used to produce embedding representations for IP addresses that have an open vocabulary.

With the multilayer neural network 400, given an IP address, whether it is seen before or not, an embedding can be generated as discussed herein. Such a generated embedding may serve as an initialized embedding and can be optimized. As IP addresses are location features, in some embodiments, their embedding representation may be trained to be distance-aware. In this case, a learning mechanism for IP address embeddings may be provided similar to the distance-aware training for embeddings for zip codes. According to the present teaching, to facilitate learning distance-aware IP address embeddings, each IP address may be mapped to a geographic coordinate. For instance, an IP address may correspond to a zip code, i.e., the coverage region of the IP address may overlap with an area represented by the zip code. In this case, coordinates of the centers of geographical areas of zip codes may be used to represent the geographical coordinates of the overlapping IP addresses. For instance, for two IP addresses, ipᵢ and ipⱼ, the corresponding golden zip codes zipᵢ and zipⱼ, can be identified, respectively, and corresponding longitude and latitude information for each may be obtained. Under this premise, such geographic information of the zip codes may be used to compute the real distances (as ground truth distance) of pairs of IP addresses which in turn can be used to calculate the loss.

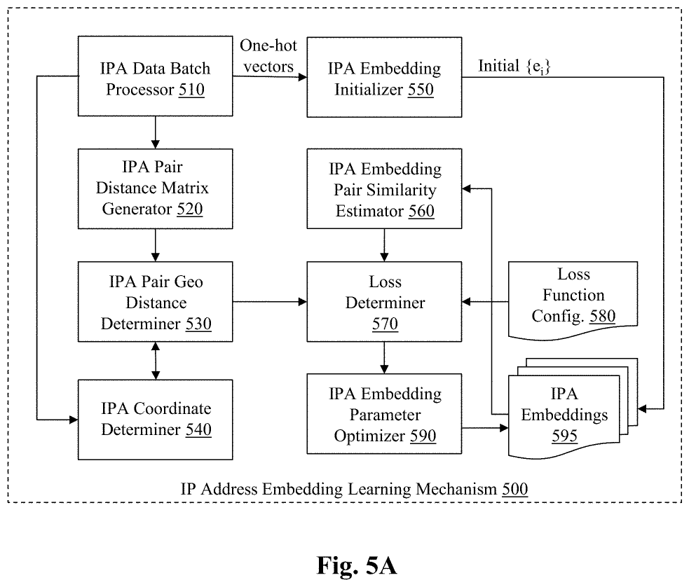

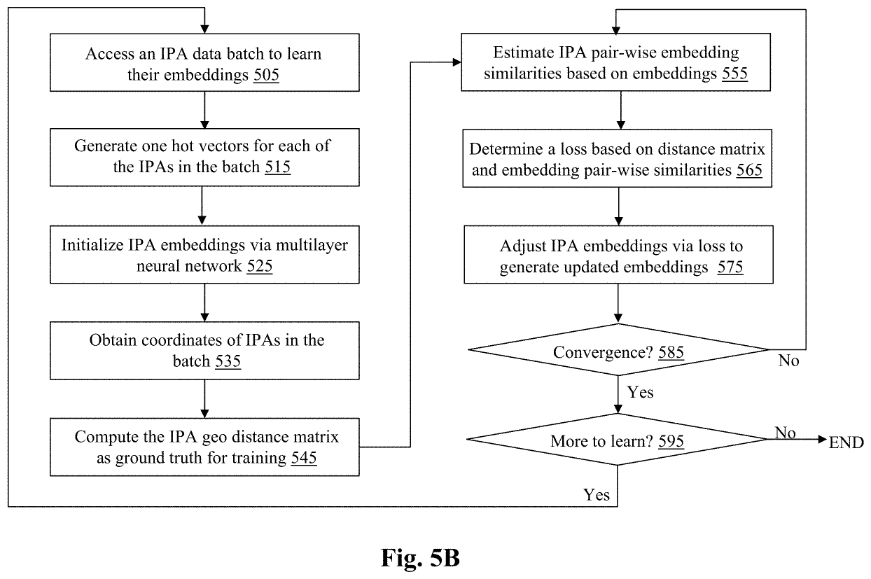

FIG. 5A depicts an exemplary high level system diagram of an IP address embedding learning mechanism 500 for learning embeddings of IP addresses with an open vocabulary, in accordance with an embodiment of the present teaching. In this illustrated embodiment, the IPA embedding learning mechanism 500 comprises an IP Address (IPA) data batch processor 510, an IPA pair distance matrix generator 520, an IPA pair geo distance determiner 530, an IPA coordinator determiner 540, an IPA embedding initializer 550, an IPA embedding pair similarity estimator 560, a loss determiner 570, and an IPA embedding parameter optimizer 590. While the learning scheme may be similar, as discussed herein, the initialization of the embeddings for IPAs is different using the multilayer neural network 400, as discussed herein with reference to FIG. 4A, in order to accommodate the open vocabulary issue. The IPA data batch processor 510 may take IPAs as input and generate the one hot vectors for each of the IPAs in the batch. Such generated one hot vectors for the IPAs in the batch are then sent to the IPA embedding initializer 550 for generating the initial embedding for each IPA based on the one hot vectors corresponding to different digits in the IPA. In some embodiments, the IPA embedding initializer 550 is implemented as the multilayer neural network 400, that takes the one hot vectors for each of the IPAs in the batch, integrates, at each layer, a one hot vector for a digit of the IPA with an output of the previous layer, and outputs an initial embedding for the IPA. The initial embedding for the IPAs in the batch may then stored in the IPA embeddings 595.

FIG. 5B is a flowchart of an exemplary process of the IPA embedding learning mechanism 500 for learning embeddings for IPAs with an open vocabulary, in accordance with an embodiment of the present teaching. In operation, when the IPA data batch processor 510 receives, at 505, a batch of IPAs, it generates, at 515, one hot vectors for each of the IPAs in the batch as shown in FIG. 4A. The one hot vectors for the IPAs in the batch are sent to the IPA embedding initializer 550, which initializes, at 525, the embeddings for the IPAs in the batch using the multilayer neural network 400 as discussed with respect to FIG. 4B. The initialized embeddings are then stored in an IPA embedding storage 595. In the meantime, the IPA pair distance matrix generator 520 is activated to obtain, at 535, the geographical coordinates for the IPAs in the batch. As discussed herein, this may be achieved based on the coordinate of the center of a region encompassed by an IPA. Alternatively, the coordinate of each IPA in the batch may be obtained based on that of an overlapping zip code identified using the approach as described herein.

Based on the coordinates of the IPAs obtained by the IPA coordinate determiner 540, the IPA pair geo distance determiner 530 computes, at 545, the pair-wise distances between any two IPAs and generates the ground truth IPA distance matrix. To learn the distance-aware embeddings for the IPAs, the IPA embedding pair similarity estimator 560 estimates, at 555, pair-wise embedding similarities based on the embeddings stored in the IPA embeddings 595. Based on the ground truth geo distances between pairs of IPAs in the IPA distance matrix and the estimated embedding similarities (computed based on the current embeddings), the loss determiner 570 computes, at 565, the loss, which is then used by the IPA embedding parameter optimizer 590 to determine how to adjust, at 575, the embedding values to minimize the loss. The learning process is iterative. If the loss indicates that the learning is not yet converged, determined at 585, the process goes back to 555, where the adjusted embeddings are again used to compute the pair-wise similarities in order to determine the next loss and adjustment for incremental learning. When the embedding learning for the current IPA data batch converges, it is determined, at 595, whether the learning process is to continue for another IPA data batch. If not, the learning process ends. If yes, the process goes back to step 505 to handle the learning of the next IPA data batch.

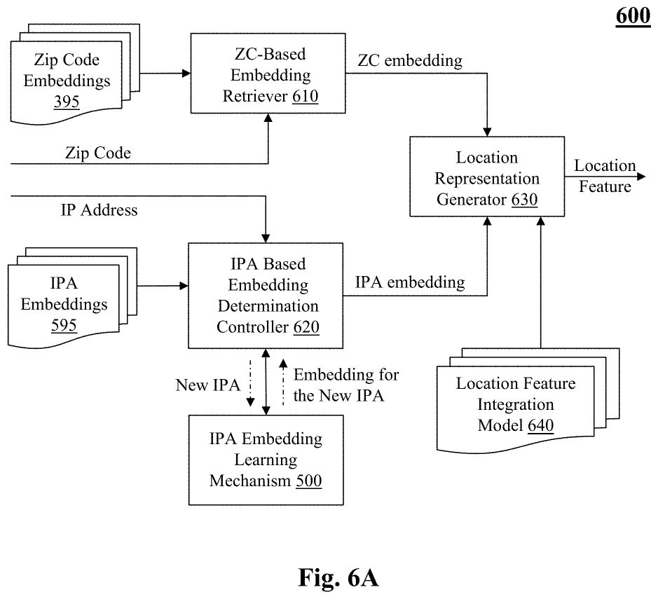

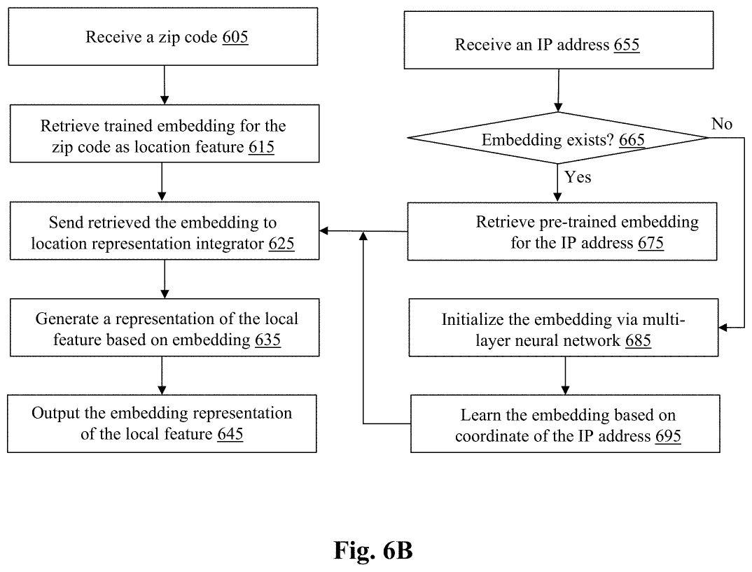

FIG. 6A depicts an exemplary high level system diagram for a location feature determiner 600 for obtaining an embedding representation of a location feature, in accordance with an embodiment of the present teaching. Relevant to the present teaching, the input to the location feature determiner 600 includes either a zip code or an IP address and the output of the location feature determiner 600 is an embedding representing the local feature received. As discussed herein, the embedding at the output is a representation of a local feature that can be used, in subsequent usage, to, e.g., predict a location for, e.g., determining ads to be displayed. The location feature determiner 600 utilizes the learned embeddings for location features from either zip codes or from IP addresses to output an embedding given a local feature provided (either a zip code or an IP address). The learned embeddings are stored in either storage 395 (obtained via learning based on zip codes) or in storage 595 (obtained via learning based on IP addresses).

In this embodiment, the location feature determiner 600 includes a ZC-based embedding estimator 610, an IPA based embedding determination controller 620, and a location representation generator 630. If the input location feature is a zip code, the ZC-based embedding estimator 610 is invoked to produce an embedding for the input zip code. As a zip code has a fixed vocabulary, the embeddings for all zip codes were learned and stored in the zip code embedding storage 395. In this situation, the ZO-based embedding estimator 610 retrieves, from 395, the embedding previously learned for the input zip code and sends to the location representation generator 630. If the input is an IP address, the IPA based embedding determination controller 620 is invoked to generate an embedding for the input IP address. Different from a zip code that has a fixed vocabulary, an IP address has an open vocabulary. Given that, an input IP address may or may not have a corresponding previously trained embedding. If an IP address is one that have been seen before with a previously trained embedding, the previous trained embedding can be retrieved by the IPA based embedding determination controller 620 from the IPA embedding storage 595 and sent to the location representation generator 630.

If the IP address does not have a previously learned embedding, i.e., either it is a new IP address not used before or was not seen previously, the IPA based embedding determination controller 620 needs to generate a new embedding, which can be done using the same method as discussed herein. To do so, the new IP address is sent to the previously described IP address embedding learning mechanism 500 so that a new embedding for the new IP address can be generated using the framework described with reference to FIGS. 4A-5B. The new embedding derived by the IP address embedding learning mechanism 500 is then provided to the IPA based embedding determination controller 620 which then sends the new embedding to both the IPA embedding storage 595 (so that it is now a previously trained embedding) and the location representation generator 630. Thus, whether the location feature received is a zip code or an IP address (old or new), the location representation generator 630 outputs a representation of the local feature based on an embedding previously trained.

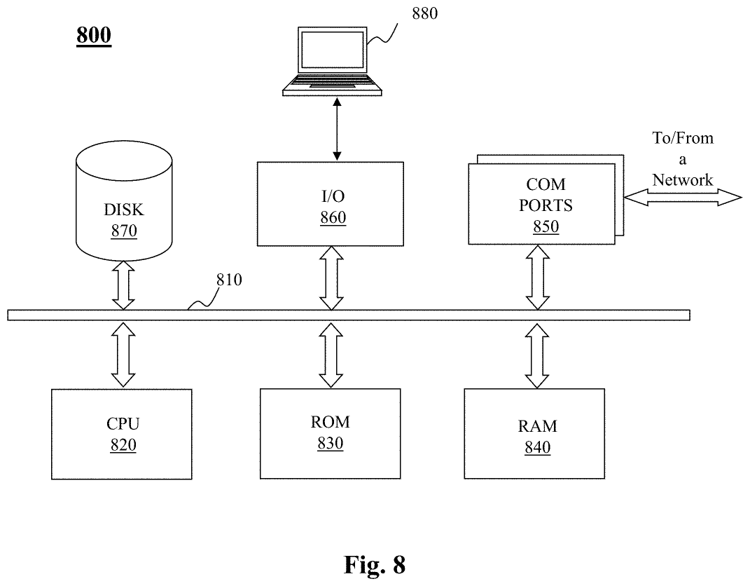

FIG. 6B is a flowchart of an exemplary process for obtaining an embedding of a location feature, in accordance with an embodiment of the present teaching. When a zip code is received, at 605, the ZC-based embedding retriever 610 retrieves, at 615 from the storage 395 for previously trained zip code embeddings, an embedding for the input zip code and sends, at 625, the retrieved embedding to the location representation generator 630. Based on the received embedding, the location representation generator 630 generates, at 635, a representation of the location feature based on the received embedding and outputs it at 645. Such a location feature embedding may then be used in the downstream tasks, such as predicting a location. On the other hand, when the IPA based embedding determination controller 620 receives, at 655, an IP address, it determines, at 665, whether the input IP address is previously known or an embedding for the IP address has been derived. If the embedding for the input IP address has been previously trained, the IPA based embedding determination controller 620 retrieves, at 675, the previously trained embedding and sends, at 625, the retrieved IP address embedding to the location representation generator 630, which then generates, at 635, a representation of the IP address based on the received embedding and outputs it at 645. If the embedding for the input IP address has not been previously trained, the IPA based embedding determination controller 620 invokes the IPA embedding learning mechanism 500 with the new IP address. As discussed herein with respect to FIGS. 4A-5B, to generate an embedding for an IP address, the IPA embedding learning mechanism 500 operates according to the flow shown in FIG. 8 by initializing, at 685, an embedding for the new IP address via the multilayer neural network 400. In some embodiments, the initialized embedding may be used as the representation of the new IP address without further optimization. In some embodiments, the initialized embedding may be further used in a learning process to learn an optimized and distance-aware embedding. As discussed herein, adjusted via the process described in FIG. 5B. For instance, the newly initialized embedding for the new IP address may be used together with other existing embeddings to compute pair-wise similarities and use that to compute the loss in order to learn, at 695, the embedding in a distance-aware manner by minimizing the loss. In this way, for a location feature that is either a zip code or an IP address, an embedding representing the location feature can be obtained. Because embedding is used, the dimension of such a location feature representation is significantly lower. As the learning is performed in a distance aware manner, the learned embeddings for location features are also distance-aware, which represents a location feature in a more semantically meaningful way.

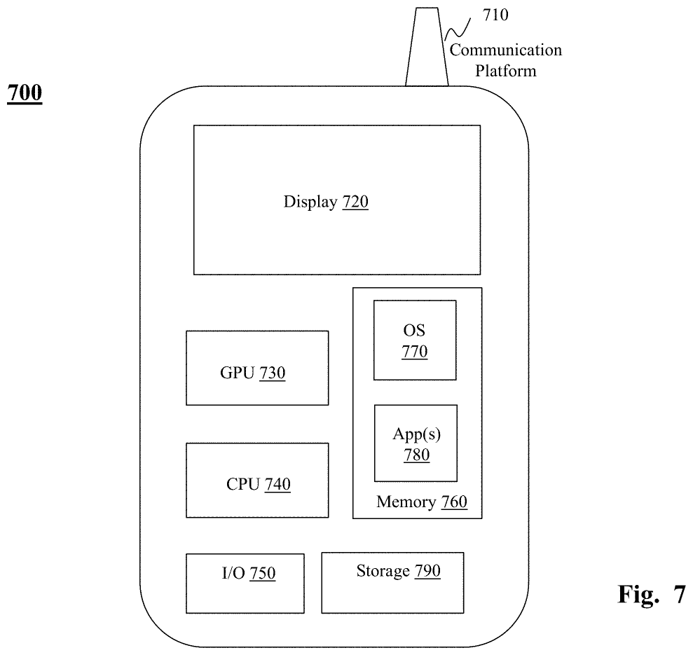

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handled gaming console, a global positioning system (GPS) receiver, and a wearable computing device, or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a user interface or any other suitable mobile apps for information analytics and management according to the present teaching on, at least partially, the mobile device 700. User interactions, if any, may be achieved via the I/O devices 750 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one processor, a memory, and a communication platform for characterizing data, comprising:
receiving a location feature;
obtaining an embedding related to the location feature with distance-awareness, wherein the embedding for the location feature is learned based on distances between different pairs of locations;
generating a representation of the location feature based on the embedding, wherein the representation of the location feature using the embedding is to be used for location related predictions.

2. The method of claim 1, wherein the location feature includes one of a zip code and an IP address.

3. The method of claim 2, wherein
the zip code has a fixed vocabulary; and
the IP address has an open vocabulary.

4. The method of claim 2, wherein the location feature is linked to a coordinate of a center of a region associated with the location feature.

5. The method of claim 4, wherein the embedding for the location feature is trained via machine learning based on a training data batch having a plurality of location features, wherein the machine learning comprises:
determining the coordinate associated with each of the location features included in the training data batch;
determining a pair-wise distance of each of pairs of location features in the training data batch based on the coordinates of the location features of the pair to generate a distance matrix;
initializing an embedding for each of the location features in the training data batch;
estimating a similarity between each of pairs of embeddings of the location features in the training data batch;
computing a loss based on the pair-wise distances of pairs of location features in the distance matrix and the similarities of embeddings of corresponding pairs of location features;
adjusting values of the embeddings of the location features by minimizing the loss; and
repeating steps of estimating, computing, and adjusting until a pre-determined condition with respect to the loss is met.

6. The method of claim 5, wherein when the location feature corresponds to a zip code,
the embedding is retrieved from a storage for previously trained embeddings for zip codes; and
the step of initializing is performed by assigning random numbers as values of each of the embeddings for the location features in the training data batch.

7. The method of claim 5, wherein when the location feature corresponds to an IP address having a plurality of digits, the step of initializing comprises:
devising a one hot vector for each of the plurality of digits to generate a corresponding plurality of one hot vectors;
feeding each of the plurality of one hot vectors to a corresponding layer of a multilayer neural network, respectively, wherein each of the plurality of layers generates, as an output, a linear combination of an input along with an activation function, the input is a concatenation of a one hot vector of a corresponding digit with an output from a previous layer;
outputting, at the last layer of the multilayer neural network, an output vector as the embedding for the location feature.

8. Machine readable and non-transitory medium having information recorded thereon for characterizing data, where the information, when read by the machine, causes the machine to perform the following steps:
receiving a location feature;
obtaining an embedding related to the location feature with distance-awareness, wherein the embedding for the location feature is learned based on distances between different pairs of locations;
generating a representation of the location feature based on the embedding, wherein the representation of the location feature using the embedding is to be used for location related predictions.

9. The medium of claim 8, wherein the location feature includes one of a zip code and an IP address.

10. The medium of claim 9, wherein
the zip code has a fixed vocabulary; and
the IP address has an open vocabulary.

11. The medium of claim 9, wherein the location feature is linked to a coordinate of a center of a region associated with the location feature.

12. The medium of claim 11, wherein the embedding for the location feature is trained via machine learning based on a training data batch having a plurality of location features, wherein the machine learning comprises:
determining the coordinate associated with each of the location features included in the training data batch;
determining a pair-wise distance of each of pairs of location features in the training data batch based on the coordinates of the location features of the pair to generate a distance matrix;
initializing an embedding for each of the location features in the training data batch;
estimating a similarity between each of pairs of embeddings of the location features in the training data batch;
computing a loss based on the pair-wise distances of pairs of location features in the distance matrix and the similarities of embeddings of corresponding pairs of location features;
adjusting values of the embeddings of the location features by minimizing the loss; and
repeating steps of estimating, computing, and adjusting until a pre-determined condition with respect to the loss is met.

13. The medium of claim 12, wherein when the location feature corresponds to a zip code,
the embedding is retrieved from a storage for previously trained embeddings for zip codes; and
the step of initializing is performed by assigning random numbers as values of each of the embeddings for the location features in the training data batch.

14. The medium of claim 12, wherein when the location feature corresponds to an IP address having a plurality of digits, the step of initializing comprises:
devising a one hot vector for each of the plurality of digits to generate a corresponding plurality of one hot vectors;
feeding each of the plurality of one hot vectors to a corresponding layer of a multilayer neural network, respectively, wherein each of the plurality of layers generates, as an output, a linear combination of an input along with an activation function, the input is a concatenation of a one hot vector of a corresponding digit with an output from a previous layer;
outputting, at the last layer of the multilayer neural network, an output vector as the embedding for the location feature.

15. A system for characterizing data, comprising:
location feature determiner configured for receiving a location feature; and
a location representation generator configured for
obtaining an embedding related to the location feature with distance-awareness, wherein the embedding for the location feature is learned based on distances between different pairs of locations, and
generating a representation of the location feature based on the embedding, wherein the representation of the location feature using the embedding is to be used for location related predictions.

16. The system of claim 15, wherein the location feature includes one of a zip code and an IP address.

17. The system of claim 16, wherein
the zip code has a fixed vocabulary; and
the IP address has an open vocabulary.

18. The system of claim 16, wherein the location feature is linked to a coordinate of a center of a region associated with the location feature.

19. The system of claim 18, wherein the embedding for the location feature is trained via machine learning based on a training data batch having a plurality of location features, wherein the machine learning comprises:
determining the coordinate associated with each of the location features included in the training data batch;
determining a pair-wise distance of each of pairs of location features in the training data batch based on the coordinates of the location features of the pair to generate a distance matrix;
initializing an embedding for each of the location features in the training data batch;
estimating a similarity between each of pairs of embeddings of the location features in the training data batch;
computing a loss based on the pair-wise distances of pairs of location features in the distance matrix and the similarities of embeddings of corresponding pairs of location features;
adjusting values of the embeddings of the location features by minimizing the loss; and
repeating steps of estimating, computing, and adjusting until a pre-determined condition with respect to the loss is met.

20. The system of claim 19, wherein when the location feature corresponds to an IP address having a plurality of digits, the step of initializing comprises:
devising a one hot vector for each of the plurality of digits to generate a corresponding plurality of one hot vectors;
feeding each of the plurality of one hot vectors to a corresponding layer of a multilayer neural network, respectively, wherein each of the plurality of layers generates, as an output, a linear combination of an input along with an activation function, the input is a concatenation of a one hot vector of a corresponding digit with an output from a previous layer;
outputting, at the last layer of the multilayer neural network, an output vector as the embedding for the location feature.
